(19) United States
(12) Patent Application Publication
(10) Pub. No.: US 2026/0154848 A1
(43) Pub. Date: Jun. 4, 2026

(54) A PHOTOMETRIC ALIGNMENT METHOD AND SYSTEM FOR A SURROUND VIEW MONITOR SYSTEM

(71) Applicant: VINAI ARTIFICIAL INTELLIGENCE APPLICATION AND RESEARCH JOINT STOCK COMPANY, Ha Noi (VN)

(72) Inventors: Tuan Anh NGUYEN, Ha Noi (VN); Thi Ngoc Diep TRAN, Ha Noi (VN); Trung Kien NGUYEN, Ha Noi (VN); Dai Thanh PHAN, Ha Noi (VN); Lai Tuan HO, Ha Noi (VN); Ho Man Rang NGUYEN, Ha Noi (VN); Duc Chan VU, Ha Noi (VN); Hai Hung BUI, Ha Noi (VN)

(21) Appl. No.: 18/730,495

(22) PCT Filed: Nov. 8, 2023
(86) PCT No.: PCT/IB2023/061252

§ 371 Date: Jul. 19, 2024

(51) Int. Cl. G06T 7/90; G06T 3/4038; G06T 5/50

(52) U.S. Cl. CPC G06T 7/90; G06T 3/4038; G06T 5/50; G06T 2207/10016; G06T 2207/10024; G06T 2207/20081; G06T 2207/20084

(57) ABSTRACT

The invention relates to a photometric alignment method and system for a surround view monitor (SV) system. The photometric alignment method uses an unsupervised network named Sync-Guided Photometric Alignment network (SGPA) which pixel-wisely aligns the SVM surround views. The photometric alignment method employs synchronization to guide pixel-wise color adjustment with losses: minimize the photometric distance between the corresponding overlap areas in the top view and keep the aligned image realistic by keeping the features of the composite image close to the features of the input images. Furthermore, the invention refers to a surround view monitor system that enables the photometric alignment method to run in real-time and reach the production level on embedded devices.

### FIELD OF THE INVENTION

An embodiment of the present disclosure relates to a photometric alignment system and method for a surround view monitor (SVM) system.

### DISCUSSION OF RELATED ART

360 Surround View Monitor system currently is an essential item in car system. By using the wide-angle cameras (e.g., fisheye camera images as illustrated in FIG. 2), it provides a surround view that helps the driver look around the car with the less number of cameras compared to the classic-angle camera system. Moreover, the system has become crucial because the synthesized surround view could eliminate blind spots and assist the drivers in parking, and low-speed maneuvering or play an important role in ADAS system. Nowadays, to build such an SVM system, the number of cameras and their positions for each car model are needed to design for calibration in such a way that the expected top view and 3D view can be obtained. In FIG. 2, an example of four fisheye images that are used in an observing SVM system is shown. After calibrating, four images are projected both in top view image and 3D bowl view in FIG. 3. With 3D bowl view, drivers could flexibly change the view angle to real-time look around the car without blind spots.

However, the cameras work independently and give us the color unbalanced images. The images of the same area captured by cameras often are different due to their auto-exposure (AE) and auto white balance (AWB) adjustment. Since there are no connections between cameras, they process the images individually by their own ISP parameters. In reality, sharing the same ISP among the cameras to synchronize the color of component views may be difficult and need changing the hardware existing in the car. In addition, for the cameras in production, it seems impossible due to the camera vendor policy. Depending on SVM product requirements, the fisheye camera selections are made and, in terms of business, they tend to have good visualization quality and usually not be expensive. Hence, most of the solutions focus on software approaches. The proposed algorithms need to be able to real-time run in edge devices as well as adapt to the car embedded systems. In addition, they need to well align not only the exposure but also the colors of input images in top view and 3D surround view.

Regarding the photometric alignment algorithms, a panorama stitching works first extracts the overlap areas of the adjacent images to measure the difference for mapping. Based on the image intensity of overlap areas, a look-up table could be estimated by the functions CRFs, IMFs to calibrate the input image photometry. On other works, for example, according to the deep learning stitching method [2], a deep model infers directly the corrected panorama image from the color-unbalanced panorama one.

Further, the photometric alignment becomes more challenging in SVM due to the inputs are projections of fisheye images, the features may be stretched and mismatched in the overlap areas. To adapt to 3D view application, [1] proposed both their SVM system and alignment algorithm which applies to each camera image the estimated gain values and tone mapping curves. The estimated parameters here are obtained effectively from the minimization of the cost functions representing intensity errors of the corresponding overlap areas. However, there are still several limitations of [1] as well as the traditional direct estimation methods. The first limitation is the global image adjustment, gain values provide globally the initial change while the curves give a further fine correction in each color to the whole image. If the misalignment of overlaps is huge, the estimation could not find converge parameters to disappear boundaries completely. Second, this method strongly depends on the overlap areas and does not consider the other areas, then it could not guarantee the outside of overlap areas to be adjusted correctly even if the color of the corresponding overlap areas is balanced. Third, if there is a need for more complicated objective functions aiming to deal with hard alignment cases, the minimization may cost time and computation. The real-time requirement might not spend enough time for converging values. In particular, these issues appear more frequently in reality as SVM faced the variation of realistic colors and uncontrollable exposure. Therefore, it is highly required to have a pixel-wise enhanced mechanism that aggregates more global information, gives local adjustments, and is able to work jointly with many objectives guiding the enhancement.

### CITATION LIST

### Non-Patent Literature

1. Yucheng Liu and Buyue Zhang. Photometric alignment for surround view camera system. In 2014 IEEE International Conference on Image Processing (ICIP), pages 1827-1831, 2014. The citation is herein referred to as [1].
2. Lang Nie, Chunyu Lin, Kang Liao, Shuaicheng Liu, and Yao Zhao. Unsupervised deep image stitching: Reconstructing stitched features to images. IEEE Transactions on Image Processing, 30:6184-6197, 2021. The citation is herein referred to as [2].

### SUMMARY OF THE INVENTION

The invention has been made to solve the above-mentioned problems, and an object of the invention is to provide a technique capable of simultaneously match the color and brightness of the surrounding cameras which aims to erase the noticeable stitching boundaries in a composite view.

According to the first aspect of the invention, there is provided a photometric alignment method for a surround view monitor system, the method comprising:
providing a training dataset comprising a plurality of training sets of four surround view images;
training a sync-guided photometric alignment (SGPA) network comprising an enhancement factor extraction (EFE) network and a recurrent image enhancement (RIE) network using the training dataset, wherein the training comprising iteratively performing:
   preprocessing a training set of surround view images comprising a left training view image, a right training view image, a front training view image and a rear training view image of the training dataset to concatenate the surround view images of the training set into a training input;
   processing the training input using the EFE network to generate a training enhancement factor;
   processing the training input and the training enhancement factor using the RIE network to generate a set of aligned surround view images;
   extracting projected and aligned top view images by projecting the set of aligned surround view images on a ground plan;
   determining overlapping aligned regions based on the projected and aligned top view images, wherein each projected top view image intersects with two neighbor projected and aligned top view images in the left and in the right of the each projected top view image to form two overlapping aligned regions;
   computing a photometric alignment loss that measures a difference between each pair of corresponding overlapping aligned regions, wherein overlapping aligned regions in each pair of corresponding overlapping aligned regions corresponds to the same ground area;
   computing a brightness loss that measures a difference between an average pixel value of each aligned surround view image in the set of aligned surround view images and an image exposure level, wherein the image exposure level measures an exposure difference between the overlapping aligned regions and corresponding overlapping regions of projected top view images of the training set;
   computing a total variation loss that measures a difference between neighboring pixels of the training enhancement factor;
   computing a color loss that measures a difference between color channels of each aligned surround view image in the set of aligned surround view images;
   computing a spatial consistency loss that measures a difference between a neighbor pixels difference of each aligned surround view image in the set of aligned surround view images and a neighbor pixels difference of each image in the training input; and
   adjusting parameters of the SGPA network by minimizing the photometric alignment loss, the brightness loss, the total variation loss, the color loss and the spatial consistency loss.

According to the second aspect of the invention, there is provided a photometric alignment system for a surround view monitor system, the photometric alignment system comprising a memory; and a processor configured to perform a photometric alignment method according to the first aspect of the invention.

### BRIEF DESCRIPTION OF THE DRAWINGS

The above and other objects, features and advantages of the invention will become more apparent to those of ordinary skill in the art by describing exemplary embodiments thereof in detail with reference to the accompanying drawings, in which:

FIG. 1 is a block diagram showing a training aspect of an example surround view monitor system according to a first embodiment of the invention.

FIG. 2 illustrates an example of a set of four surround view images captured from four fisheye cameras.

FIG. 3 illustrates unbalance composite surround views as shown in a top view image and a 3D surround view image.

FIG. 4 is a block diagram showing an inference aspect of an example surround view monitor system according to a second embodiment of the invention.

FIG. 5 is a flow diagram of an example process for photometric alignment.

FIG. 6 shows a data distribution of experimental data.

FIG. 7A illustrates a top view image and a 3D view image applied the traditional method.

FIG. 7B illustrates a top view image and a 3D view image applied the method of the invention.

FIG. 7C illustrates a top view image and a 3D view image applied sequentially the combination of the method of the invention and the traditional method.

FIG. 8A illustrates a top view image and a 3D view image of a traditional method failure case.

FIG. 8B illustrates the overlapping regions in each projected top view image of a traditional method failure case that are used for the traditional method alignment.

FIG. 8C illustrates a top view image and a 3D view image in the traditional method failure case applied the traditional method.

FIG. 8D illustrates a top view image and a 3D view image in the traditional method failure case applied subsequently the traditional method and the method of the invention.

FIG. 8E illustrates a top view image and a 3D view image in the traditional method failure case applied only the method of the invention.

FIG. 8F illustrates top view color channel images and 3D view color channel images in the traditional method failure case without applying alignment methods, applied the traditional method, applied subsequently the traditional method and the method of the invention and applied the method of the invention.

### DETAILED DESCRIPTION OF EXEMPLARY EMBODIMENTS

While the invention may have various modifications and alternative forms, specific embodiments thereof are shown by way of example in the drawings and will be described herein in detail. However, there is no intent to limit the invention to the particular forms disclosed. On the contrary, the invention is to cover all modifications, equivalents, and alternatives falling within the spirit and scope of the appended claims.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/of” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings, the same or corresponding components are denoted by the same reference numerals regardless of reference numbers, and thus the description thereof will not be repeated.

And throughout the detailed description and claims of the present disclosure, the term “training/trained” or “learning/learned” refers to performing machine learning through computing according to a procedure. It will be appreciated by those skilled in the art that it is not intended to refer to a mental function such as human educational activity.

As used herein, a model is trained to output a predetermined output with respect to a predetermined input, and may include, for example, neural networks. A neural network refers to a recognition model that simulates a computation capability of a biological system using a large number of artificial neurons being connected to each other through edges.

The neural network uses artificial neurons configured by simplifying functions of biological neurons, and the artificial neurons may be connected to each other through edges having connection weights. The connection weights, parameters of the neural network, are predetermined values of the edges, and may also be referred to as connection strengths. The neural network may perform a cognitive function or a learning process of a human brain through the artificial neurons. The artificial neurons may also be referred to as nodes.

A neural network may include a plurality of layers. For example, the neural network may include an input layer, a hidden layer, and an output layer. The input layer may receive an input to be used to perform training and transmit the input to the hidden layer, and the output layer may generate an output of the neural network based on signals received from nodes of the hidden layer. The hidden layer may be disposed between the input layer and the output layer. The hidden layer may change training data received from the input layer to an easily predictable value. Nodes included in the input layer and the hidden layer may be connected to each other through edges having connection weights, and nodes included in the hidden layer and the output layer may also be connected to each other through edges having connection weights. The input layer, the hidden layer, and the output layer may respectively include a plurality of nodes.

Hereinafter, training a neural network refers to training parameters of the neural network. Further, a trained neural network refers to a neural network to which the trained parameters are applied.

Basically, the neural network may be trained through supervised learning or unsupervised learning. Supervised learning refers to a method of providing input data and label corresponding thereto to the neural network, while in unsupervised learning, the input data provided to the neural network does not contain label.

As used throughout this disclosure, the term “autonomous vehicle” refers to a vehicle capable of implementing at least one navigational change without driver input. A navigational change refers to a change in one or more of steering, braking, or acceleration/deceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects to the driver (e.g., braking or braking under certain circumstances). In some cases, autonomous vehicles may handle some or all aspects of braking, speed control, and/or steering of the vehicle.

As human drivers typically rely on visual cues and observations in order to control a vehicle, transportation infrastructures are built accordingly, with lane markings, traffic signs, and traffic lights designed to provide visual information to drivers. In view of these design characteristics of transportation infrastructures, an autonomous vehicle may include a camera and a processing unit that analyzes visual information captured from the environment of the vehicle. The visual information may include, for example, images representing components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while it is traveling, and the vehicle (as well as other vehicles) may use the information to localize itself on the model. Some vehicles can also be capable of communication among them, sharing information, altering the peer vehicle of hazards or changes in the vehicles' surroundings, etc.

A vehicle as described in this disclosure may include, for example, a car or a motorcycle, or any suitable motorized vehicle. Hereinafter, a car will be described as an example.

A vehicle as described in this disclosure may be powered by any suitable power source, and may be, for example, an internal combustion engine vehicle including an engine as a power source, a hybrid vehicle including both an engine and an electric motor as a power source, and/or an electric vehicle including an electric motor as a power source.

A camera as described in this disclosure may include, but is not limited to, various optical and non-optical imaging devices, like an RGB camera, stereovision camera or any device whose output data may be used in perceiving the environment. Other imaging devices capable of observing objects may also be used, such as ultrasonic sensors, sonar, LIDAR, and LADAR devices. Thus, various combinations of one or more cameras and sensors may be used.

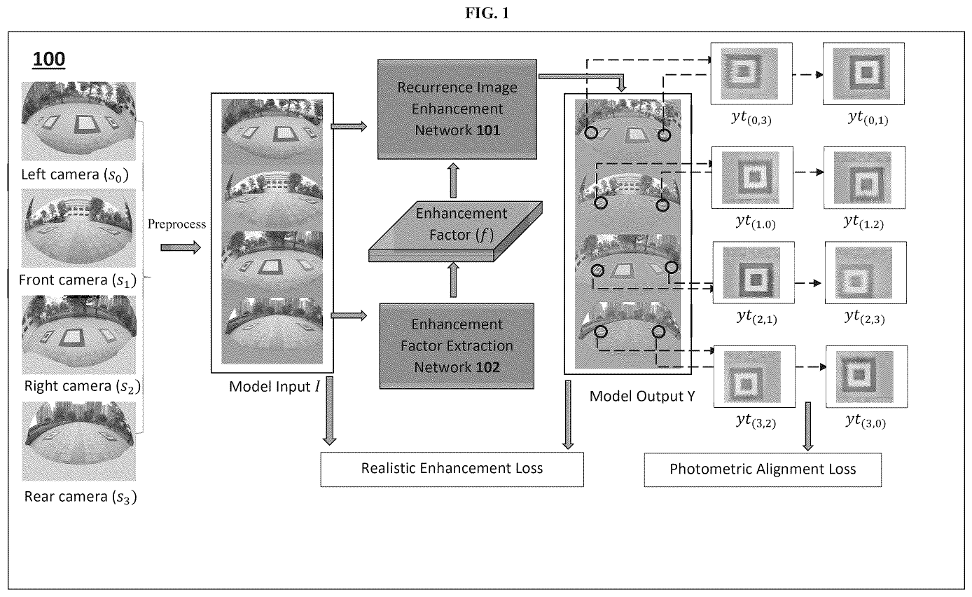

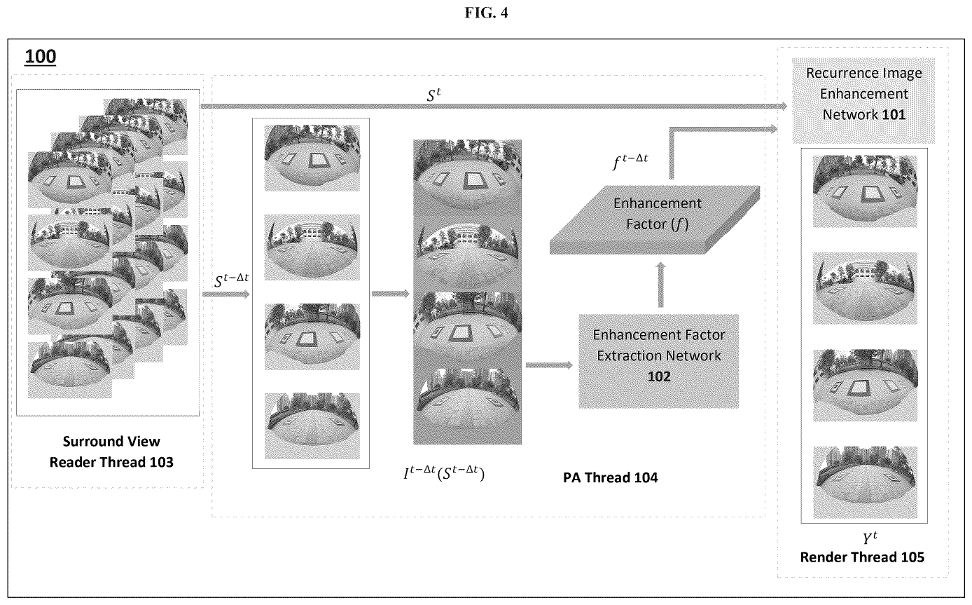

FIG. 1 and FIG. 4 are the block diagrams showing an example surround view monitor (SVM) system (hereinafter, the system 100) in which FIG. 1 shows a training aspect of the system 100 and FIG. 4 shows an inference aspect of the system 100.

According to a first embodiment of the invention as illustrated in FIG. 1, the system 100 comprises a memory (not shown) and a processor (not shown) configured to train a sync-guided photometric alignment (SGPA) network so that after being trained the SGPA network is able to perform a photometric alignment method.

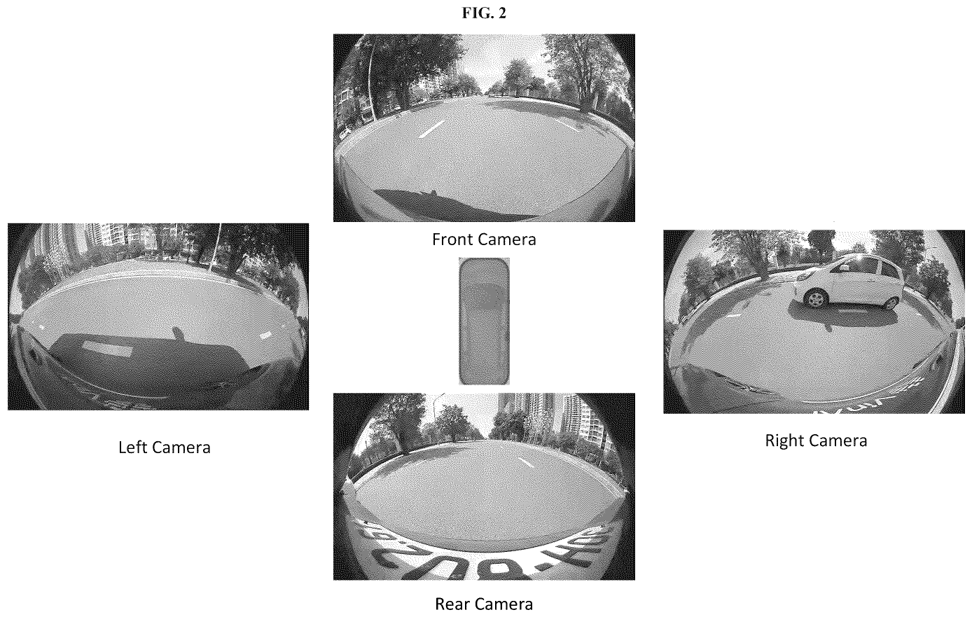

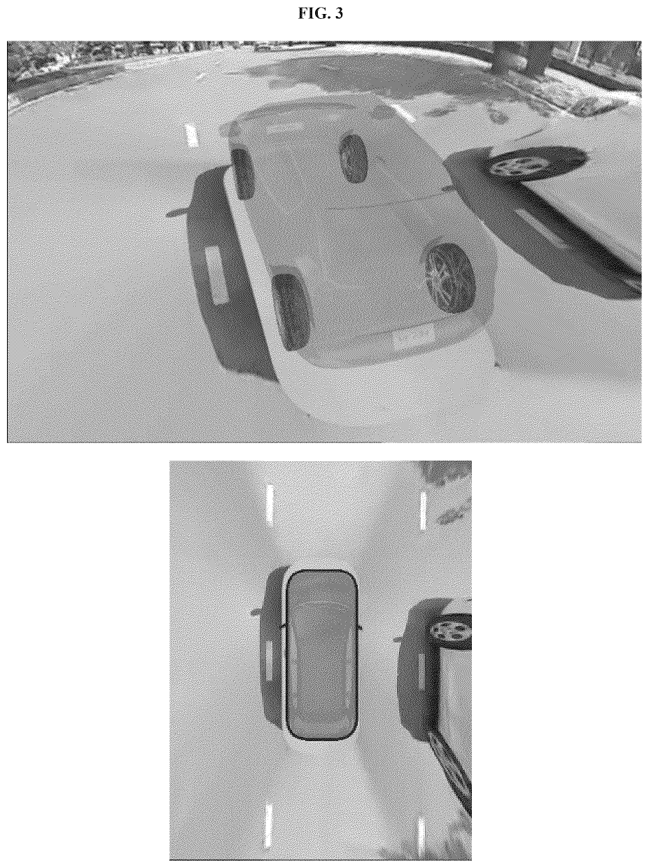

A training dataset comprising a plurality of training sets of four surround view images is prepared for the training. The training dataset captured from driving scenarios for photometric alignment training. FIG. 2 illustrates an example of a training set of surround view images S={sᵢ}, ∀i∈{left, front, right, rear} that includes a left training view image s_{left}, a right training view image s_{right}, a front training view image s_{front} and a rear training view image sᵣₑₐᵣ from four cameras installed in the front bumper, the rear bumper, the left side mirror and the right side mirror of a vehicle. From now on, we will refer to the indices 0 through 3 as corresponding to left, front, right, and rear respectively for more convenience. Therefore, a training set of surround view images is denoted as S={sᵢ}, ∀i∈{0, 1, 2, 3}. In practice, the training set of surround view images S are obtained independently and had different auto exposure and white balance settings that causes the unbalance composite surround views as shown in a top view image and a 3D surround view image illustrated in FIG. 3.

The SGPA network comprises an enhancement factor extraction (EFE) network 102 and a recurrent image enhancement (RIE) network 101 which are trained using the training set.

The system 100 preprocesses the training set S by replacing areas of the surround view images that disappear in a composite surround view image of the training set S with average values representing the training set S. The preprocessing further comprises concatenating the surround view images of the training set S into a training input I.

The system 100 processes the training input I using the EFE network 102 to generate training enhancement factors f={fᵢ}, i∈{0, 1, 2, 3} where fᵢ is a training enhancement factor of a surround view image that SGPA network aligns. Then, the system 100 processes the training input I and the training enhancement factor f using the RIE network 101 to generate a set of aligned surround view images Y={yᵢ}, i∈{0, 1, 2, 3} where yᵢ is a surround view image that the SGPA network aligns.

To conduct the training process using a top view projection technique for learning, the system 100 calibrates a transformation function [symbol] ( ), to extract projected and aligned top view images by projecting the set of aligned surround view images Y on a ground plan. Specifically, suppose x is a pixel index in the surround view image yᵢ, where i∈{0, 1, 2, 3}, the corresponding position of x in the projected and aligned top view images px is calculated by using the calibration function [symbol] ( ), px= [symbol] (x), and inverse calibration function [symbol] ( ) is used to calculate the opposite side, x= [symbol] (px). Thus, if T is a composite top view image of Y generated by merging the projected and aligned top view images of Y, T=Merge(ytᵢ) where i∈{0, 1, 2, 3}, where ytᵢ is a projected top view image of y, then T[px]=Y[x]. Due to the calibration depends on the vehicle type design, a fixed pair (px, x) list is prepared for the quick projection tasks. It is contemplated that T is extracted by indexing Y so the backpropagation of top view information learning to generalize the gradient computation is guaranteed.

It is known that one surround view image intersects with two neighboring view images (i.e., a left view image and a right view image) to form overlapping aligned regions based on the projected and aligned top view images. For the output set of aligned surround view images Y, lets ω={yt_{(i,j)}}, where i∈{0, 1, 2, 3}, and j∈{(i−1)%4, (i+1)%4}(% is the modulo operator) is the set of overlapping aligned regions in each aligned surround view image ytᵢ, where yt_{(i,j)} is an overlapping aligned region of ytᵢ at the adjacent side j in a given ground plane location. yt_{(i,j)} is defined in as follows:

$${yt}_{( i , j )} = {yt}_{i} \vert {yt}_{i} ⋂ {yt}_{j} for \qquad ( Equation 1 )$$

$$∀ i ∈ \{ 0 , 1 , 2 , 3 \} , and ∀ j ∈ \{ ( i - 1 ) \%4 , ( i + 1 ) \%4 \}$$

Similarly, θ={st_{(i,j)}}, where i∈{0, 1, 2, 3}, and j∈{(i−1)%4, (i+1)%4} being the set of specific overlapping regions in each projected top view image stᵢ of sᵢ is defined.

According to an embodiment, each overlapping aligned region is a selected square top view area as illustrated in FIG. 1. According to another embodiment, each overlapping aligned region may be selected from various shapes such as triangle, rectangular, diamond, etc.

The system 100 uses a photometric alignment loss and a realistic enhancement loss to train the SGPA network.

The photometric alignment loss Lₚₐ measures a difference between each pair of corresponding overlapping aligned regions in which overlapping aligned regions in each pair of corresponding overlapping aligned regions corresponds to a same ground area. In particular, the photometric alignment loss is defined as:

$${L}_{pa} = {\sum }_{i = 0}^{3} {L}_{matching} ( {yt}_{( i , [ i + 1 ] \%4 )} , {yt}_{( [ i + 1 ] \%4 , i )} ) \qquad ( Equation 2 )$$

where L_{matching}(o, o′) is a matching loss of two overlapping aligned regions o and o′. L_{matching}(o, o′) is defined as:

$${L}_{matching} ( o , {o}^{′} ) = {L}_{ol \_ spa} ( o , {o}^{′} ) + {λ}_{ol \_ bri} {L}_{ol \_ bri} ( o , {o}^{′} ) \qquad ( Equation 3 )$$

where λ_{ol_bri} is set to 10 for a best outcome.

L_{ol_spa}(o, o′) is a spatial consistency loss term that maintains a spatial consistency between overlapping aligned regions o and o′. Specifically, L_{ol_spa}(o, o′) measures a difference between a neighbor pixels difference of o and a neighbor pixels difference of o′. L_{ol_spa}(o, o′) is expressed as:

$${L}_{ol \_ spa} ( o , {o}^{′} ) = \frac{1}{N} {\sum }_{i = 1}^{N} [ {\sum }_{j ∈ ϕ ( i )} {( \vert {P}_{i} ( o ) - {P}_{j} ( o ) \vert - \vert {P}_{i} ( {o}^{′} ) - {P}_{j} ( {o}^{′} ) \vert )}^{2} + α {\sum }_{j ∈ ω ( i )} {( \vert {P}_{i} ( o ) - {P}_{j} ( o ) \vert - \vert {P}_{i} ( {o}^{′} ) - {P}_{j} ( {o}^{′} ) \vert )}^{2} ] \qquad ( Equation 4 )$$

where P is an average pooling operation that divides its input in a grid map of N local regions and output their mean values. φ(i) and ω(i) are neighbor sets: (top, down, left, right), and (top left, top right, lower left, lower right), respectively. α is set to 0.5.

The overlap brightness matching loss term L_{ol_bri}(o, o′) maintains the exposure of o and o′ which is defined as:

$${L}_{ol \_ bri} ( o , {o}^{′} ) = \frac{1}{N} {\sum }_{m = 1}^{N} \vert {P}_{m} ( o ) - {P}_{m} ( {o}^{′} ) \vert \qquad ( Equation 5 )$$

The realistic enhancement loss measures the quality of Y and provides an image enhancement which is guided by the photometric alignment loss to all surround view images. The realistic enhancement loss comprises a brightness loss, a total variation loss, a color loss, and a spatial consistency loss.

The brightness loss aims to seek a brightness for all regions of the set of aligned surround view images Y that both satisfy photometric balance requirements and is close to the inputs. In particular, the brightness loss L_{bri} measures a difference between an average pixel value of each aligned surround view image in the set of aligned surround view images Y and an image exposure level Eₚₐ. The image exposure level Eₚₐ measures an exposure difference between the overlapping aligned regions and corresponding overlapping regions of projected top view images of the training set S.

In particular, the image exposure level Eₚₐ for the brightness loss L_{bri} is calculated as:

$${E}_{pa} = E ( I ) + max ( \frac{1}{M} ( {\sum }_{yt ∈ ω} E ( yt ) - {\sum }_{st ∈ ϕ} E ( st ) ) , {λ}_{e} ) \qquad ( Equation 6 )$$

where E is average operation which computes the exposure of its input and λₑ is set as 0.4 to make output Y be not enhanced darkly.

The brightness loss L_{bri} is built with Eₚₐ computed from Equation (6) as bellow:

$${L}_{bri} = \frac{1}{K} {\sum }_{i = 1}^{K} \vert {Q}_{i} ( Y ) - {E}_{pa} \vert \qquad ( Equation 7 )$$

where K is the number of local grids created by splitting Y with average pooling operation Q.

The total variation loss Lₜᵥ measures a difference between neighboring pixels of the training enhancement factor f. The total variation loss Lₜᵥ is calculated as:

$${L}_{tv} = \frac{1}{CHW} {\sum }_{c = 1}^{C} {\sum }_{h = 1}^{H} {\sum }_{w = 1}^{W} [ {( {∇}_{horizontal} {f}_{c , h , w} )}^{2} + {( {∇}_{vertical} {f}_{c , h , w} )}^{2} ] \qquad ( Equation 8 )$$

where, C, H and W are the dimension sizes of the training enhancement factor f, ∇_{horizontal} and ∇_{vertical} represent the horizontal and vertical gradient operations.

The color loss L_{color} measures a difference between color channels of each aligned surround view image in the set of aligned surround view images Y. The color loss L_{color} is calculated as:

$${L}_{color} = {\sum }_{∀ ( i , j ) ∈ ζ} \sqrt{{( E ( {X}^{i} ) - E ( {X}^{j} ) )}^{2}} \qquad ( Equation 9 )$$

where ζ of X is the set of RGB channels pairs, ζ={(Red, Green), (Red, Blue), (Green, Blue)}.

Similar to L_{ol_spa} loss term, the spatial consistency Lₛₚₐ measures a difference between a neighbor pixels difference of each aligned surround view image in the set of aligned surround view images Y and a neighbor pixels difference of each image in the training input I. The spatial consistency Lₛₚₐ is calculated as:

$${L}_{spa} = \frac{1}{K} {\sum }_{i = 1}^{K} [ {\sum }_{j ∈ ϕ ( i )} {( \vert {Q}_{i} ( Y ) - {Q}_{j} ( Y ) \vert - \vert {Q}_{i} ( I ) - {Q}_{j} ( I ) \vert )}^{2} + α {\sum }_{j ∈ ψ ( i )} {( \vert {Q}_{i} ( Y ) - {Q}_{j} ( Y ) \vert - \vert {Q}_{i} ( I ) - {Q}_{j} ( I ) \vert )}^{2} ] \qquad ( Equation 10 )$$

A total loss of the SGPA network is combined as follows:

$${L}_{total} = {λ}_{spa} {L}_{pa} + {λ}_{bri} {L}_{bri} + {λ}_{tv} {L}_{tv} + {λ}_{color} {L}_{color} + {λ}_{spa} {L}_{spa} \qquad ( Equation 11 )$$

$$where {λ}_{pa} = {λ}_{bri} = {λ}_{tv} = {λ}_{color} = {λ}_{spa} = 1.$$

The system 100 adjusts parameters of the SGPA network to complete the training by minimizing the total loss comprising the photometric alignment loss, the brightness loss, the total variation loss, the color loss and the spatial consistency loss.

According to a second embodiment of the invention as illustrated in FIG. 4, after being trained, the SGPA network is able to perform a photometric alignment method.

Assuming that Δt is the alignment inference processing time to output a photometric alignment. Because of this processing time, if the alignment inference is run for every SVM image and run alternately this process and render process, the render process will not continuously run since slowly receiving the input from the alignment inference process. To deal with this, a skipping strategy is designed to skip alignment inference process for some incoming SVM view sets and align them by the calculated alignments of the past view sets. Lets

$${S}^{t - Δ t} = \{ {s}_{i}^{t - Δ t} \} , {S}^{t} = \{ {s}_{i}^{t} \} and {S}^{t + Δ t} = \{ {s}_{i}^{t + Δ t} \} ,$$

∀i∈{0, 1, 2, 3} are the sets of four raw surround views at time t−Δt, t and t+Δt, respectively. Instead of processing every incoming surround view set, the alignment inference skipping strategy calculates the alignment results of S^{t-Δt}, S^{t} and S^{t+Δt}. Based on this calculation, the results of S^{t-Δt} are applied to align S^{t} and incoming inputs from time t to t+Δt while waiting the alignment calculation of S^{t}. Similarly, the results of S^{t} are applied while waiting the next alignment calculation S^{t+Δt}.

The proposed architecture includes three threads running parallelly: a photometric alignment (PA) thread 104 that is the integration of the SGPA network; a surround view reader thread 103 that provides images of the surround view from cameras and a render thread 105 that renders the corrected surround view images in the top view image and 3D surround view image.

Referring to FIG. 4, the system 100 provides, by the surround view reader thread 103, a first set of surround view images S^{(t-Δt)} at timestamp t−Δt comprising a left view image, a right view image, a front view image and a rear view image.

In this operation, the system 100 may further preprocess the first set of surround view images S^{(t-Δt)} using operation as described in FIG. 1 to form a preprocessed input I^{t-Δt}(S^{t-Δt}).

Next, the system 100 provides, by the surround view reader thread 103, a second set of surround view images S^{t} at timestamp t.

Next, the system 100 processes, by the PA thread 104, the first set of surround view images S^{(t-Δt)} using the trained EFE network 102 to generate a first enhancement factor f^{t-Δt}. According to another embodiment, the first set of surround view images S^{(t-Δt)} may be pre-processed to the preprocessed input I^{t-Δt}(S^{t-Δt}) using operation as described in FIG. 1 before being processed by the trained EFE network 102.

Next, the system 100 processes, by the render thread 105, the second set of surround view images S^{t} and the first enhancement factor f^{t-Δt} using the trained RIE network 101 to generate a second set of aligned surround view images

$${Y}^{t} = \{ {y}_{i}^{t} \} ,$$

∀i∈{0, 1, 2, 3} at timestamp t. The final enhanced output

$${y}_{i}^{t}$$

is computed after n recurrence steps as below.

$${Y}_{n}^{t} = \{ {y}_{i , n}^{t} \} = \{ \begin{matrix}{s}_{i}^{t} + {f}_{i}^{t - Δ t} ( {( {s}_{i}^{t} )}^{2} - {s}_{i}^{t} ) , n = 1 \\ {y}_{i , n - 1}^{t} + {f}_{i}^{t - Δ t} ( {( {y}_{i , n - 1}^{t} )}^{2} - {y}_{i , n - 1}^{t} ) , n > 1\end{matrix} . \qquad ( Equation 12 )$$

$$∀ i ∈ \{ 0 , 1 , 2 , 3 \}$$

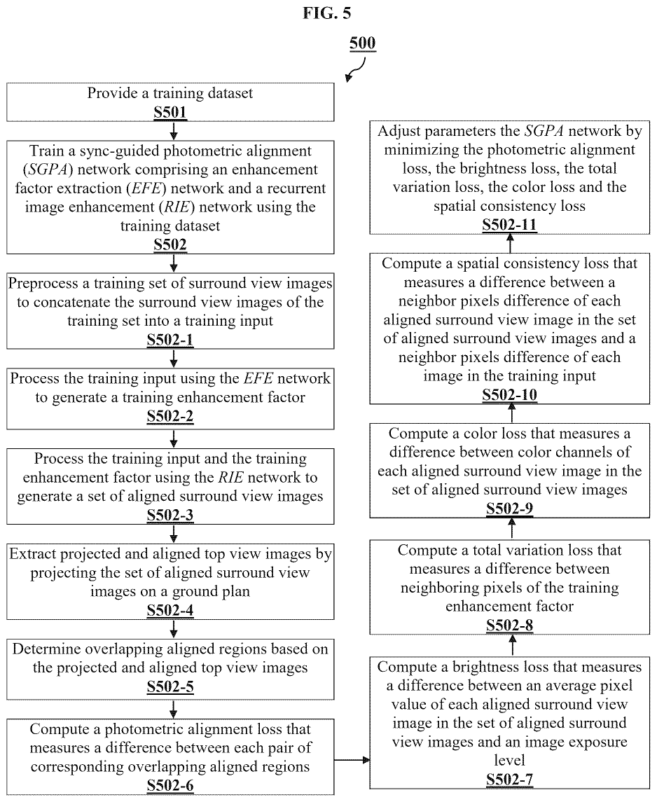

FIG. 5 is a flow diagram of an example process 500 for photometric alignment. For convenience, the process 500 will be described as being performed by a surround view monitor system 100 (hereinafter referred to as “the system”) of FIG. 1 and FIG. 4.

According to the first embodiment, the process 500 comprises steps S501 and S502.

In step S501, the system provides a training dataset comprising a plurality of training sets of four surround view images. The plurality of training sets of four surround view images is captured independently and had different auto exposure and white balance settings from four cameras installed in the front bumper, the rear bumper, the left side mirror and the right side mirror of a vehicle.

In step S502, the system trains a sync-guided photometric alignment (SGPA) network comprising an enhancement factor extraction (EFE) network (for example, the EFE network 102 of FIG. 1) and a recurrent image enhancement (RIE) network (for example, the RIE network 101 of FIG. 1) using the training dataset, wherein the training comprising iteratively performing sub-steps S502-1 to S502-11.

In sub-step S502-1, the system preprocesses a training set of surround view images S comprising a left training view image (for example, s_{left} of FIG. 1), a right training view image (for example, s_{right} of FIG. 1), a front training view image (for example, s_{front} of FIG. 1) and a rear training view image (for example, sᵣₑₐᵣ of FIG. 1) of the training dataset to concatenate the surround view images of the training set into a training input (for example, the training input I of FIG. 1).

According to an embodiment, sub-step S502-1 further comprising replacing areas of the surround view images that disappear in a composite surround view image of the training set S with average values representing the training set S.

In step S502-2, the system processes the training input I using the EFE network to generate a training enhancement factor (for example, the training enhancement factor f of FIG. 1).

In step S502-3, the system processes the training input I and the training enhancement factor f using the RIE network to generate a set of aligned surround view images (for example, the set of aligned surround view images Y of FIG. 1).

In step S502-4, the system extracts projected and aligned top view images by projecting the set of aligned surround view images Y on a ground plan.

In step S502-5, the system determines overlapping aligned regions based on the projected and aligned top view images, wherein each projected top view image intersects with two neighbor projected and aligned top view images in the left and in the right of the each projected top view image to form two overlapping aligned regions. Specifically, the determining of the overlapping aligned regions is described in accordance with Equation 1 in the description of FIG. 1, so the detailed description thereof is omitted for brevity.

In step S502-6, the system computes a photometric alignment loss Lₚₐ that measures a difference between each pair of corresponding overlapping aligned regions, wherein overlapping aligned regions in each pair of corresponding overlapping aligned regions corresponds to a same ground area.

The photometric alignment loss Lₚₐ comprises a spatial consistency loss term L_{ol_spa} that maintains a spatial consistency between each pair of corresponding overlapping aligned regions and an overlap brightness matching loss term L_{ol_bri} that maintains the exposure between each pair of corresponding overlapping aligned regions.

Specifically, the spatial consistency loss term L_{ol_spa} measures a difference between a first difference between neighbor local areas of a first overlapping aligned region in the each pair of corresponding overlapping aligned regions and a second difference between the neighbor local areas of a second overlapping aligned region in the each pair of corresponding overlapping aligned regions. Specifically, L_{ol_spa} is described in accordance with Equation 4 in the description of FIG. 1, so the detailed description thereof is omitted for brevity.

The overlap brightness matching loss term L_{ol_bri} measures a brightness difference between the first overlapping aligned region and the second overlapping aligned region. Specifically, L_{ol_bri} is described in accordance with Equation 5 in the description of FIG. 1, so the detailed description thereof is omitted for brevity.

In step S502-7, the system computes a brightness loss L_{bri} that measures a difference between an average pixel value of each aligned surround view image in the set of aligned surround view images Y and an image exposure level Eₚₐ, wherein the image exposure level Eₚₐ measures an exposure difference between the overlapping aligned regions and corresponding overlapping regions of projected top view images of the training set S.

The projected top view images of the training set S are extracted by projecting the training set on a ground plan; and each projected top view image of the training set S intersects with two neighbor projected top view images in the left and in the right of the each top view image to form two overlapping regions of the training set S.

Specifically, L_{bri} is described in accordance with Equations 6 & 7 in the description of FIG. 1, so the detailed description thereof is omitted for brevity.

In step S502-8, the system computes a total variation loss Lₜᵥ that measures a difference between neighboring pixels of the training enhancement factor f. Specifically, Lₜᵥ is described in accordance with Equation 8 in the description of FIG. 1, so the detailed description thereof is omitted for brevity.

In step S502-9, the system computes a color loss L_{color} that measures a difference between color channels of each aligned surround view image in the set of aligned surround view images Y. Specifically, L_{color} is described in accordance with Equation 9 in the description of FIG. 1, so the detailed description thereof is omitted for brevity.

In step S502-10, the system computes a spatial consistency loss Lₛₚₐ that measures a difference between a neighbor pixels difference of each aligned surround view image in the set of aligned surround view images Y and a neighbor pixels difference of each image in the training input I. Specifically, Lₛₚₐ is described in accordance with Equation 10 in the description of FIG. 1, so the detailed description thereof is omitted for brevity.

In step S502-11, the system adjusts parameters of the EFE network and the RIE network of the SGPA network by minimizing the photometric alignment loss Lₚₐ, the brightness loss L_{bri}, the total variation loss Lₜᵥ, the color loss L_{color} and the spatial consistency loss Lₛₚₐ.

According to a second embodiment, the process 500 further comprising steps (a) to (e).

In step (a), the system provides a photometric alignment (PA) thread (for example, the PA thread 104 of FIG. 4), a surround view reader thread (for example, the surround view reader thread 103 of FIG. 4) and a render thread (for example, the render thread 105 of FIG. 4) which run parallelly in an inference phase.

In step (b), the system provides, by the surround view reader thread, a first set of surround view images S^{(t-Δt)} at timestamp t−Δt comprising a left view image, a right view image, a front view image and a rear view image.

In step (c), the system provides, by the surround view reader thread, a second set of surround view images S^{t} at timestamp t;

In step (d), the system processes, by the PA thread, the first set of surround view images S^{(t-Δt)} of timestamp t−Δt using the trained EFE network to generate a first enhancement factor f^{t-Δt} of timestamp t−Δt, at time timestamp t.

In step (e), the system processes, by the render thread, the second set of surround view images S^{t} and the first enhancement factor f^{-Δt} using the trained RIE network to generate a second set of aligned surround view images Y^{t} at timestamp t.

### Experiments

### 1. Training and Evaluating Dataset

Training and testing a data-driven photometric alignment model requires a large number of surround view sets. The previous works are limited both in the definition of photometric alignment cases, the variety collection. Therefore, the experiments construct PA-SVM, a large-scale photometric alignment dataset for both training and testing.

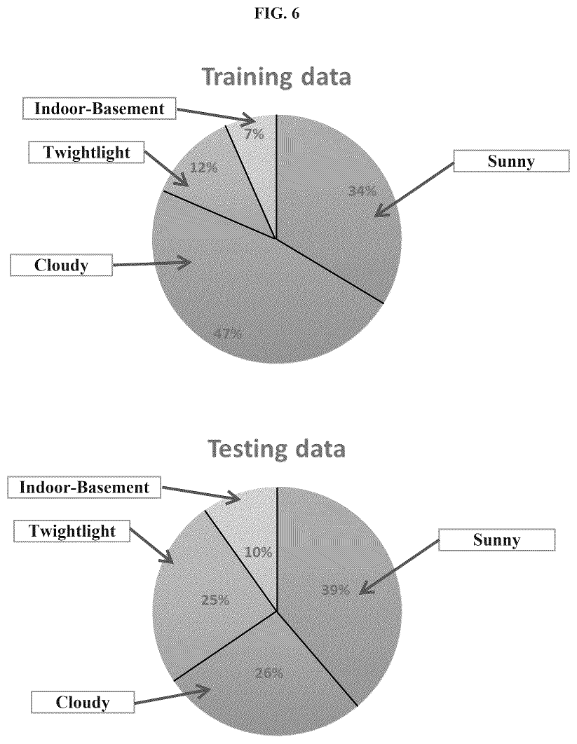

To build PA-SVM, the experiments use a SVM system of a commercial car to collect the sets of four surround views, the example is shown in FIG. 2. The calibration of SVM system is provided for the cameras, they are set to capture the surround view without blind spots. For data collection, the car is driven on various days and capture the driving scenarios in reality including both the indoor and outdoor environments such as cityscapes, crowded streets, highways, countryside, parking, basement, etc. However, to deal with photometric learning, the experiments divide the data into three photometric classes that most affect the surround view: sunny light, cloudy light, and twilight light. Based on that definition, the test set is selected in time and roads different from train data and the experiments focus on evaluating the method of the invention on those popular conditions: sunny, cloudy, and twilight. To this end, the experiments collect 48427 sets of four surround images, 79% data is used for training, and 21% is for testing. The data distribution is illustrated in FIG. 6.

If there is a car that comes with a new calibration, to perform photometric alignment for the new configuration, the experiments deform the images of their surround view to match overlap areas to training data's overlap positions before feeding to the photometric alignment process of the invention. The deformation defines corners of the corresponding overlap areas as the controlling points and interpolates the pixels of new calibration' images following the movements of the controlling points.

### 2. Comparisons

As mentioned in the above description, the better photometric alignment method provides the smaller total loss Lₜₒₜₐₗ. The experiments compare the method of the invention to others on our large-scale dataset PA-SVM. The total loss comparison of methods on the individual photometric classes is illustrated in Table 1.

TABLE 1
Photometric alignment results

| Method | Sunny | Cloudy | Twilight | Basement | Average |
|---|---|---|---|---|---|
| SVM without | 0.78 | 1.10 | 0.85 | 0.70 | 0.86 |
| photometric alignment | | | | | |
| T-PA: Traditional method | 0.59, ↓24% | 0.71, ↓35% | 0.49, ↓42% | 0.38, ↓46% | 0.58, ↓33% |
| D-PA: deep-learning PA | 0.41, ↓47% | 0.54, ↓51% | 0.34, ↓60% | 0.24, ↓66% | 0.41, ↓52% |
| C-PA: T-PA + D-PA | 0.38, ↓51% | 0.50, ↓55% | 0.35, ↓59% | 0.22, ↓69% | 0.39, ↓55% |

The deep learning based method D-PA of the invention shows the huge enhancing improvement where the combination C-PA of D-PA and the traditional method T-PA (according to [1]) achieved the best enhancement in general, it reduces overall PA-SVM dataset loss from 0.86 to 0.39, 55% reduction comparing to 33% of traditional method T-PA [1] and 52% of only using D-PA inference.

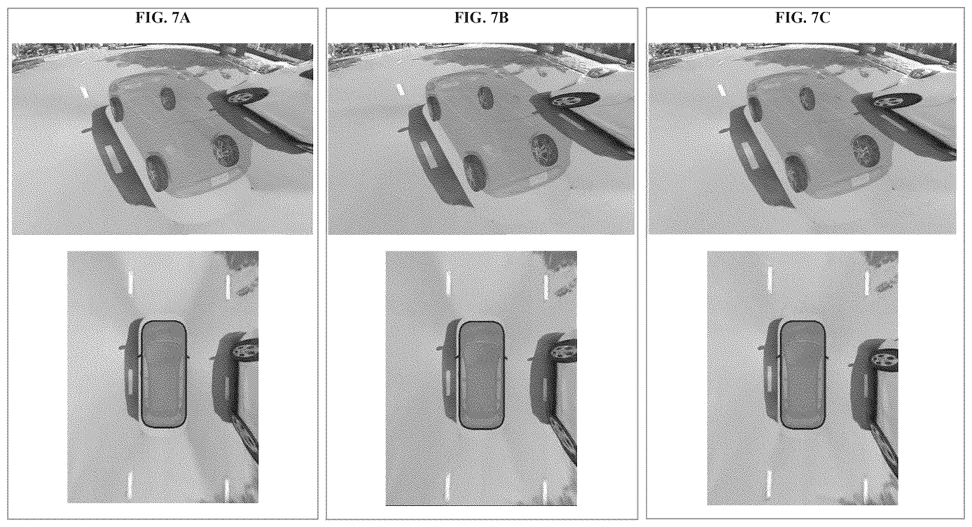

FIG. 7A shows a top view image and a 3D view image applied the traditional method. FIG. 7B shows a top view image and a 3D view image applied the method of the invention D-PA. FIG. 7C shows a top view image and a 3D view image applied sequentially the traditional method T-PA and the method of the invention D-PA, called C-PA. It can be seen that the D-PA visually bring a better alignment result as compared to the traditional method. In particular, C-PA illustrates that D-PA could improve the result of the traditional method such as T-PA and provide the better results of individually using T-PA or D-PA.

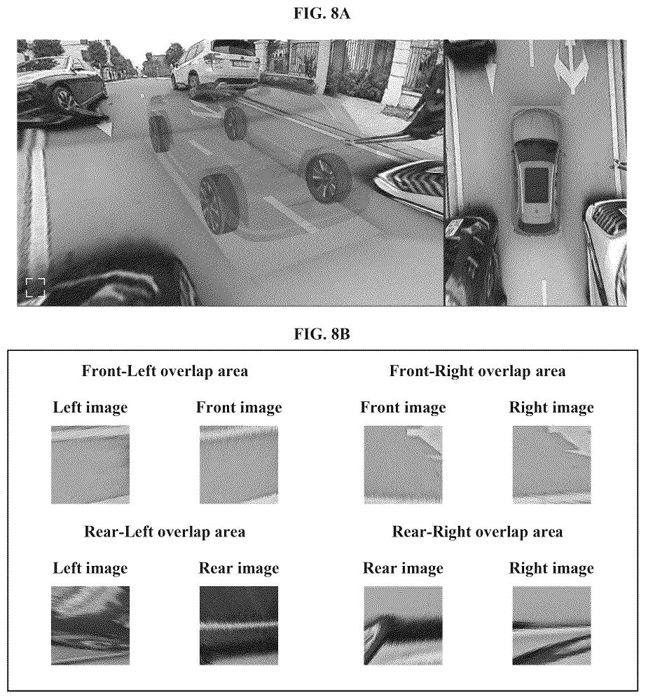

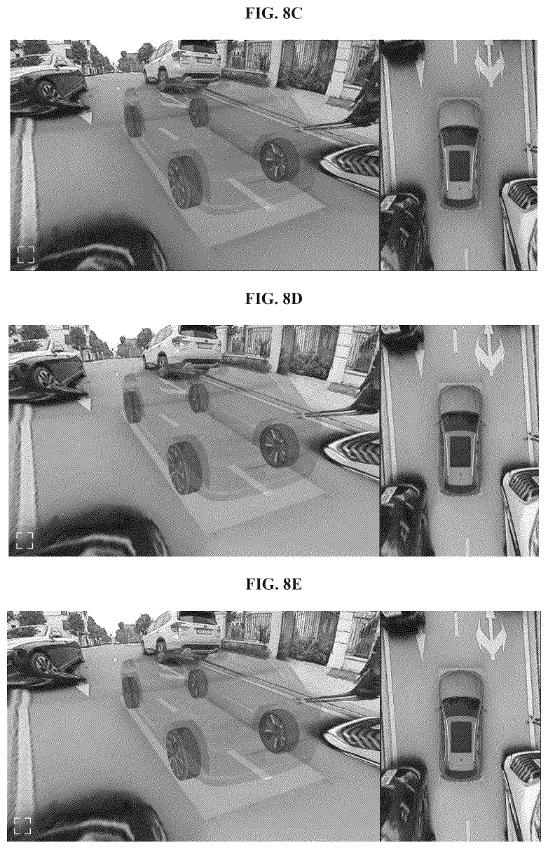

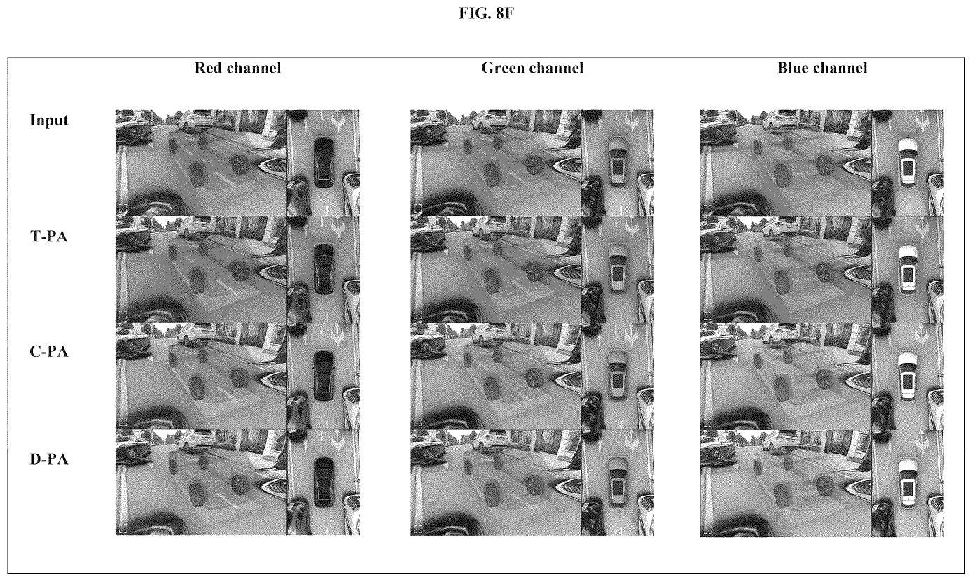

FIG. 8A shows a top view image and a 3D view image of a traditional method failure case (T-PA). FIG. 8B shows the specific overlapping regions in each projected top view image of the traditional method failure case that are used for the traditional method alignment T-PA. FIG. 8C shows a top view image and a 3D view image in the traditional method failure case applied the traditional method. FIG. 8D shows a top view image and a 3D view image in the traditional method failure case applied subsequently the traditional method T-PA and the method of the invention D-PA (C-PA). FIG. 8E shows a top view image a 3D view image in the traditional method failure case applied only the method of the invention (D-PA). FIG. 8F illustrates top view color channel images and 3D view color channel images in the traditional method failure case without applying alignment methods, applied T-PA, applied C-PA, and applied D-PA. It can be seen that, in FIG. 8B, the corresponding overlap areas of this case are significantly mismatched due to the top view projections of two adjacent cameras stretch the same objects in different ground plan directions. In particular, the Rear-Left overlap area in this case shows the huge feature difference between the left view image and the rear view image. For this reason, the results of T-PA (FIG. 8C) shows worse than the original input (FIG. 8A). Additionally, D-PA (FIG. 8E) visually bring the best alignment results, it is better than C-PA (FIG. 8D) since the C-PA method includes the T-PA method inside. FIG. 8F shows more clearly the comparison in three color channels of the above results in which the front view is used as the photometric reference for aligning. Due to the above limitation of the traditional method (T-PA), the color channels, especially the red channel, of the left view, the right view and the rear view are adjusted incorrectly and their photometric are different from the front view while the method (D-PA) of the invention shows an opposite result.

The experiments also illustrate that the deep learning method of the invention D-PA could align the images well with 3% smaller than the combination C-PA, 19% better than the traditional method. In some cases, the D-PA shows that it works better than the combination such as the experiments of twilight class. This can be explained by the traditional method [1] support generally the inference of the SGPA network of the invention, however the global photometric alignment does not always work well. In practice, the in-correction of global estimation method often happens when the corresponding overlaps consists of the stretching objects at the top view that the calibration stretches the same objects of two adjacent views in different directions and yield the mismatch between the two adjacent top view as mentioned above. This issue can be dealt with by checking the mismatch of the top view overlap images by a threshold to decide whether using traditional method [1] to preprocess the raw input before feeding to the SGPA network. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A photometric alignment method for a surround view monitor system, the method comprising:
providing a training dataset comprising a plurality of training sets of four surround view images;
training a sync-guided photometric alignment (SGPA) network comprising an enhancement factor extraction (EFE) network and a recurrent image enhancement (RIE) network using the training dataset, wherein the training comprising iteratively performing:
preprocessing a training set of surround view images comprising a left training view image, a right training view image, a front training view image and a rear training view image of the training dataset to concatenate the surround view images of the training set into a training input;
processing the training input using the EFE network to generate a training enhancement factor;
processing the training input and the training enhancement factor using the RIE network to generate a set of aligned surround view images;
extracting projected and aligned top view images by projecting the set of aligned surround view images on a ground plan;
determining overlapping aligned regions based on the projected and aligned top view images, wherein each projected top view image intersects with two neighbor projected and aligned top view images in the left and in the right of the each projected top view image to form two overlapping aligned regions;
computing a photometric alignment loss that measures a difference between each pair of corresponding overlapping aligned regions, wherein overlapping aligned regions in each pair of corresponding overlapping aligned regions corresponds to a same ground area;
computing a brightness loss that measures a difference between an average pixel value of each aligned surround view image in the set of aligned surround view images and an image exposure level, wherein the image exposure level measures an exposure difference between the overlapping aligned regions and corresponding overlapping regions of projected top view images of the training set;
computing a total variation loss that measures a difference between neighboring pixels of the training enhancement factor;
computing a color loss that measures a difference between color channels of each aligned surround view image in the set of aligned surround view images;
computing a spatial consistency loss that measures a difference between a neighbor pixels difference of each aligned surround view image in the set of aligned surround view images and a neighbor pixels difference of each image in the training input; and
adjusting parameters of the SGPA network by minimizing the photometric alignment loss, the brightness loss, the total variation loss, the color loss and the spatial consistency loss.

2. The method of claim 1, wherein the photometric alignment loss comprises a spatial consistency loss term that maintains a spatial consistency between each pair of corresponding overlapping aligned regions and an overlap brightness matching loss term that maintains the exposure between each pair of corresponding overlapping aligned regions.

3. The method of claim 2, wherein:
the spatial consistency loss term measures a difference between a first difference between neighbor local areas of a first overlapping aligned region in the each pair of corresponding overlapping aligned regions and a second difference between the neighbor local areas of a second overlapping aligned region in the each pair of corresponding overlapping aligned regions; and
the overlap brightness matching loss term measures a brightness difference between the first overlapping aligned region and the second overlapping aligned region.

4. The method of claim 3, wherein the plurality of training sets of four surround view images is captured independently and had different auto exposure and white balance settings from four cameras installed in the front bumper, the rear bumper, the left side mirror and the right side mirror of a vehicle.

5. The method of claim 4, wherein the preprocessing further comprising replacing areas of the surround view images that disappear in a composite surround view image of the training set with average values representing the training set.

6. The method of claim 5, wherein:
the top view images of the training set are extracted by projecting the training set on a ground plan; and
each projected top view image of the training set intersects with two neighbor top view images in the left and in the right of the each top view image to form two overlapping regions of the training set.

7. The method of claim 6, wherein each overlapping aligned region are a selected square top view area.

8. The method of claim 7 further comprising:
providing a photometric alignment (PA) thread, a surround view reader thread and a render thread which run parallelly in an inference phase;
providing, by the surround view reader thread, a first set of surround view images at timestamp t−Δt comprising a left view image, a right view image, a front view image and a rear view image;
providing, by the surround view reader thread, a second set of surround view images at timestamp t;
processing, by the PA thread, the first set of surround view images of timestamp t−Δt using the trained EFE network to generate a first enhancement factor of timestamp t−Δt, at time timestamp t; and
processing, by the render thread, the second set of surround view images and the first enhancement factor using the trained RIE network to generate a second set of aligned surround view images at timestamp t.

9. The method of claim 8 further comprising:
producing a composite surround view image including a top view image and a 3D surround view image based on the first set of aligned surround view images at timestamp t.

10. A photometric alignment system for a surround view monitor system, the photometric alignment system comprising:
a memory; and
a processor configured to perform a photometric alignment method, the method comprising:
providing a training dataset comprising a plurality of training sets of four surround view images;
training a sync-guided photometric alignment (SGPA) network comprising an enhancement factor extraction (EFE) network and a recurrent image enhancement (RIE) network using the training dataset, wherein the training comprising iteratively performing:
preprocessing a training set of surround view images comprising a left training view image, a right training view image, a front training view image and a rear training view image of the training dataset to concatenate the surround view images of the training set into a training input;
processing the training input using the EFE network to generate a training enhancement factor f;
processing the training input and the training enhancement factor f using the RIE network to generate a set of aligned surround view images;
extracting projected and aligned top view images by projecting the set of aligned surround view images on a ground plan;
determining overlapping aligned regions based on the projected and aligned top view images, wherein each projected top view image intersects with two neighbor projected and aligned top view images in the left and in the right of the each projected top view image to form two overlapping aligned regions;
computing a photometric alignment loss that measures a difference between each pair of corresponding overlapping aligned regions, wherein overlapping aligned regions in each pair of corresponding overlapping aligned regions corresponds to a same ground area;
computing a brightness loss that measures a difference between an average pixel value of each aligned surround view image in the set of aligned surround view images and an image exposure level, wherein the image exposure level measures an exposure difference between the overlapping aligned regions and corresponding overlapping regions of top view images of the training set;
computing a total variation loss that measures a difference between neighboring pixels of the training enhancement factor f;
computing a color loss that measures a difference between color channels of each aligned surround view image in the set of aligned surround view images;
computing a spatial consistency loss that measures a different between a neighbor pixels difference of each aligned surround view image in the set of aligned surround view images and a neighbor pixels difference of each image in the training input; and
adjusting parameters of the SGPA network by minimizing the photometric alignment loss, the brightness loss, the total variation loss, the color loss and the spatial consistency loss.
